(19) United States
(12) Patent Application Publication
(10) Pub. No.: US 2025/0180739 A1
(43) Pub. Date: Jun. 5, 2025

(54) MEASURING STATION

(71) Applicant: DEGOULD LIMITED, Exeter, Devon (GB)

(72) Inventors: Daniel George GOULD, Exeter, Devon (GB); Spyridon KARACHALIOS, Exeter, Devon (GB)

(21) Appl. No.: 18/840,666

(22) PCT Filed: Feb. 14, 2023
(86) PCT No.: PCT/GB2023/050329

§ 371 Date: Aug. 22, 2024

(30) Foreign Application Priority Data
Feb. 23, 2022 (GB) 2202453.3

(51) Int. Cl. G01S 17/42; G01S 7/48

(52) U.S. Cl. CPC G01S 17/42; G01S 7/4808

(57) ABSTRACT

A measuring station for measuring an object, the measuring station including measuring columns to define a measurement space between them, wherein each measuring column includes a range finding sensor, and a servo motor. Each servo motor is configured to rotate a respective range finding sensor about its rotation axis, the range finding sensor being rotated across a first scanning angle directed into the measurement space in a movement plane. Each range finding sensor is configured to transmit and receive ranging signals in a second scanning angle in a scanning plane, the scanning plane being non-parallel with respect to the movement plane. The measuring station further includes a controller configured to receive range data from the range finding sensors and use the range data in combination with position and angle data from the servo motors to generate a scale, three-dimensional map of the object.

### CROSS-REFERENCE TO RELATED APPLICATIONS

This application is a national stage filing of International Application No. PCT/GB2023/050329 filed on Feb. 14, 2023 (corresponding to International Publication WO 2023/161605), which in turn claims priority to GB 2202453.3 filed on Feb. 23, 2022.

The entire contents of both of these applications are hereby incorporated by reference.

### FIELD

Embodiments described herein relate generally to methods and apparatus for the accurate measurement of large objects.

### BACKGROUND

There are many situations in which it can be desirable to measure the dimensions of a large object. In one example, when a large object such as a boat or industrial vehicle is being transported by boat, it may be desirable to ascertain the length, width, and height of the object for stowage planning purposes to ensure that the capacity of the boat is not exceeded. Where an object is relatively small, this can be done to a satisfactory standard by hand using a measure device such as a tape measure. However, where an object is relatively large, hand measurement becomes more difficult and can be less accurate. Moreover, measurements can be time consuming and generally inaccurate. Human error combined with different techniques and skills of the operator all contribute to the difficulty in consistently measuring an object.

Once the object has been measured, the dimensions are checked against those supplied, anomalies identified, and the optimum location and orientation determined, in order to achieve the most efficient use of loading space on the ship. With hundreds or in some cases thousands of objects on each ship, the number of different possible loading configurations can quickly run into the millions. At present, much of this work is done manually and the configuration is heavily influenced by the order that the objects arrive at the ship.

### SUMMARY

The present disclosure discloses a type of measurement system that can have one or more of the following advantages over known ways of measuring a large object:
improved accuracy of measurement;
improved speed of measurement;
improved consistency of measurement;
ability to measure an increased number of dimensions of the object; and
achieve an optimum configuration for loading objects that can minimize the space used.

In accordance with a first aspect there is provided a measuring station according to claim 1.

Thus, the measuring station according to the first aspect enables an object such a boat to be moved into a measuring space and a plurality of range finding sensor are each swept by respective servo motors through respective scanning angles across a respective movement plane to obtain data to build the scale, three-dimensional map of the object, such as a point cloud. Since the scanning plane of each range finding sensor is non-parallel with respect to the movement plane, a scanning space is defined as the sensor is moved through the measurement space and parts of the object within the swept volume that defines the scanning space can be modelled in the scale, three-dimensional map of the object. Since the position of each servo motor and sensor is known, the map can be used by a computing device to obtain true scale measurements such as length, width, and height dimensions of the object in a fast, accurate and/or consistent manner. Moreover, due to the number of voxels that can be generated in such a three-dimensional map, the number of measurements that can be taken can be greater than would be feasible if measurement were performed by hand. Generally, objects are measured in three dimensions: the overall width, length and height to form a cuboid of the object's maximum dimensions. However, objects such as a ship or crane may consist of irregular surfaces and voids which are not accounted for, taking up more space than might otherwise be needed. The measuring station can enable better use of space by enabling such features to be considered during the planning process.

Various features are set out in the dependent claims.

In accordance with a second aspect, there is provided a method according to claim 12.

In accordance with a third aspect, there is provided a method according to claim 13.

In accordance with a fourth aspect, there is provided a measuring station for measuring an object, the measuring station comprising: first to fourth measuring columns, each measuring column being positioned at a respective corner of a quadrilateral to define a measurement space between them; wherein each measuring column comprises a lidar emitter and a lidar receiver, and a servo motor coupled to the lidar emitter and lidar receiver; wherein a rotation axis of each servo motor is positioned to be a first distance from a rotation axis of an adjacent servo motor located in a first direction, and a second distance from the rotation axis of another adjacent servo motor located in a second direction, and wherein the first direction and the second direction are orthogonal to each other wherein each servo motor is configured to rotate a respective lidar emitter and lidar receiver about its rotation axis and at a servo rotation rate, the lidar emitter and lidar receiver being rotated across a first scanning angle directed into the measurement space in a movement plane, wherein each lidar emitter and lidar receiver is configured to transmit and receive lidar signals in a second scanning angle in a scanning plane, the scanning plane being non-parallel with respect to the movement plane, and wherein the measuring station further comprises a controller configured to receive lidar data from the lidar receivers and use the lidar data in combination with position and angle data from the servo motors to generate a scale, three-dimensional map of the object.

The measurement station according to the fourth aspect has analogous advantages to those of the first aspect but can result in a more accurate 3D model of the object.

The first and third lidar emitters and lidar receivers can be mounted on non-adjacent measuring columns, i.e. diagonally opposite columns, and the second and fourth lidar emitters and lidar receivers can be mounted on non-adjacent measuring columns, i.e. diagonally opposite columns, which are distinct from the columns on which the first and third lidar emitters and lidar receivers are mounted. Thus, the first and third can be on opposite rather than adjacent corners of the quadrilateral and the second and fourth can be on opposite rather than adjacent corners of the quadrilateral. The first and third lidar emitters and lidar receivers can be mounted at a first mounting height which is greater than a second mounting height at which the second and forth lidar emitters and lidar receivers are mounted. In some embodiments, the first and third lidar emitters and lidar receivers can be mounted at a respective first mounting heights which are distinct from one another but each of which is greater than the mounting height or heights at which the second and forth lidar emitters and lidar receivers are mounted. Such an arrangement enables adjacent pairs of lidar emitters and receivers to scan a side or end of the object from above and below, increasing the likelihood of surface features defining the maximum length, width and/or height of the object being registered in the three-dimensional map. The first height can be greater than 5 metres and the second height can be less than 5 meters. In one example, the first height can be at least 7.5 metres and the second height can be less than or equal to 2 metres.

The scanning plane can be arranged at an angle of between 45 degrees and 135 degrees with respect to the movement plane. The scanning plane can be arranged at an angle of between 75 degrees and 100 degrees with respect to the movement plane and more specifically an angle of 90 degrees, which can provide an optimum scanning space utilizing the full width of the second scanning angle as the emitters/receivers are moved across the first scanning angle.

The first scanning angle i.e. the angle through which the emitter/receiver is rotated can be between 60 and 180 degrees and in some embodiments between 110 and 150 degrees. This can ensure that each lidar emitter and lidar receiver can “see” the facing surfaces of the object as the servo motor completes a measurement sweep, even in embodiments where fewer than four, for example two or three, measurement columns are provided. Where the first scanning angle is greater than 90 degrees, it can start with the measurement plane being outside of the quadrilateral such that the servo motor sweeps the emitter/receiver into, through and out of the measurement space. The center of the first scanning angle can for example be centered at the middle of the measurement space. An angle between 90 and 150 degrees may provide a good balance between rotation time and object scanning, with 90 degrees being an example. However, where a smaller object is to be measured, embodiments can utilize a smaller scanning angle such as between 25 and 60 degrees, in one example 45 degrees, centered on the middle of the measurement space; in such embodiments, the servo rotation rate can be decreased to provide a model of increased resolution without increasing the scanning time in comparison to a faster servo rotation rate across a larger angle.

The second scanning angle i.e. the measurement or beam fan angle of each emitter/receiver can be between 60 and 180 degrees and in some embodiments between 110 and 150 degrees. This can ensure that each lidar emitter and lidar receiver can “see” facing surfaces of the object. The second scanning angle can be between 90 and 150 degrees, with 90 degrees being an example. In embodiments where the second height i.e. the height at which lower emitters/receivers are mounted is less than or equal to 2 metres, it can be advantage to have a second scanning angle for the lower emitters/receivers which is greater than 90 degrees, for example at least 120 or 150 degrees, so that upper side surfaces of the object can be seen by the lower emitters/receivers. The center of the second scanning angle can be centered at the middle of the measurement space.

The first distance can be between 5 and 30 metres and the second distance can be between 5 and 30 metres. This can enable the measurement system to map and measure long and/or wide objects such as vehicles or boats. In some embodiments the first distance can be between 10 and 25 metres and the second direction can be between 10 and 25 metres. The first distance can be greater than the second distance, which can reduce the footprint of the measurement system by accounting for the fact that many object such as vehicles and boats are longer than they are wide.

The servo rotation rate can be between 3 and 18 degrees per second.

The movement plane can be horizontal and the scanning plane can be vertical with respect to a ground plane on which the quadrilateral is defined. As will be appreciated, the terms horizontal and vertical can be true horizontal and vertical relative to the ground plane, or in some embodiments the horizontal scanning angle can be more horizontal than vertical, and the vertical scanning angle can be more vertical than horizontal. Alternatively, the fixed orientation of the servo motors can be rotated relative to the above arrangement by over 45 degrees, such as 90 degrees, such that the servo motors sweep the laterally scanning lidar units vertically through the measurements space the; in such embodiments, reference to “a rotation axis of each servo motor” can refer to the point on the rotation axis of each servo motor that corresponds to the lidar emission region.

In accordance with a fifth aspect, there is provided a method of measuring an object in a measuring station, the method comprising: at a measuring station according the first aspect: receiving an object into the measurement space for measuring; rotating the lidar emitters and lidar receivers through the first scanning angle while emitting and receiving lidar signals in the second scanning angle using the lidar emitters and lidar receivers of each measuring column; generating a three-dimensional map of the object based on the received lidar signals, the servo motor rotation rate, and the first and second distances; and determining a measurement of the object using the three-dimensional map.

In embodiments where the first and third emitters/receivers are mounted at a greater height than the second and fourth emitters/receivers, the step of generating a three-dimensional map of the object can be on the received lidar signals, the servo motor rotation rate, the first and second distances and the heights of the first to fourth emitters/receivers.

In accordance with a sixth aspect, there is provided an apparatus for measuring dimensions of an object, the apparatus comprising one or more processors; a non-transitory memory; and one or more programs, wherein the one or more programs are stored in the non-transitory memory and configured to be executed by the one or more processors, the one or more programs including instructions for performing the method of the second, third or fifth aspects.

In accordance with a seventh aspect, there is provided a non-transitory computer readable storage medium storing one or more programs, the one or more programs comprising instructions, which, when executed by an electronic device with one or more processors, cause the electronic device to perform the method of the second, third or fifth aspects.

Features including optional features of the fourth and fifth aspects can be applied to the first, second and third aspects in an analogous manner.

### BRIEF DESCRIPTION OF DRAWINGS

In the following, embodiments will be described with reference to the drawings in which:

FIG. 1 shows a top-down view of a measuring station according to an embodiment;

FIG. 2 shows two measuring columns of the measuring station of FIG. 1;

FIG. 3 shows a flowchart of a method for measuring dimensions of an object according to an embodiment; and

FIG. 4 shows a system of modules for controlling the measuring station of FIG. 1.

### DETAILED DESCRIPTION

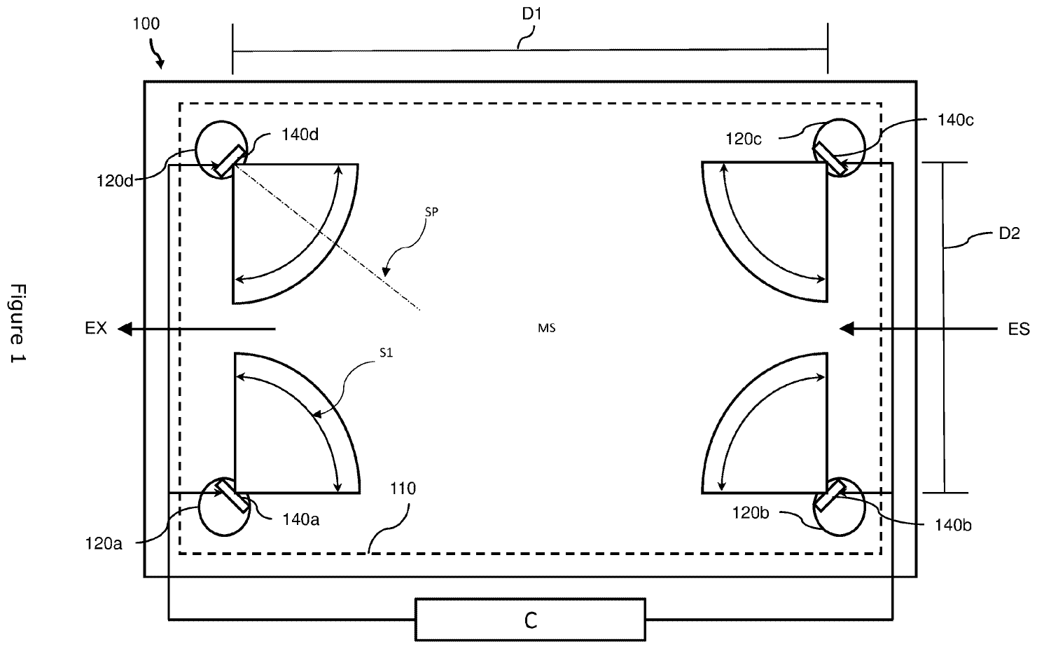

FIG. 1 shows a measuring station 100 for making a precise measurement of the dimensions of an object. The object may be a large vehicle, for instance, a car, a heavy goods vehicle, a boat, or any other large form of transport. The object may alternatively be a large piece of industrial equipment. For the purposes of the present application, the object may for example have an overall length L, an overall width W and an overall height H in the range of up to 20 meters, 9 meters and 7 meters respectively.

The measuring station 100 defines an area 110, wherein first to fourth measuring columns 120a, 120b, 120c, and 120d are arranged in the area 110. The first to fourth measuring columns 120a, 120b, 120c, and 120d form a quadrilateral in the area 110, such that each of the first to fourth measuring column 120a, 120b, 120c, and 120d is positioned in a respective corner of the quadrilateral.

The area 110 has an entry side ES arranged for an object to enter the measuring station 100 and an exit side EX, distinct from the entry side ES, for the object to move out of the measuring station 100. This enables an object such as a boat to be driven on a ground plane into the measuring station 100, measured, and then easily moved out of the opposite side to be moved onto a boat for example. It will, however, be appreciated that any side can be used as an entry side and any side can be used as an exit side.

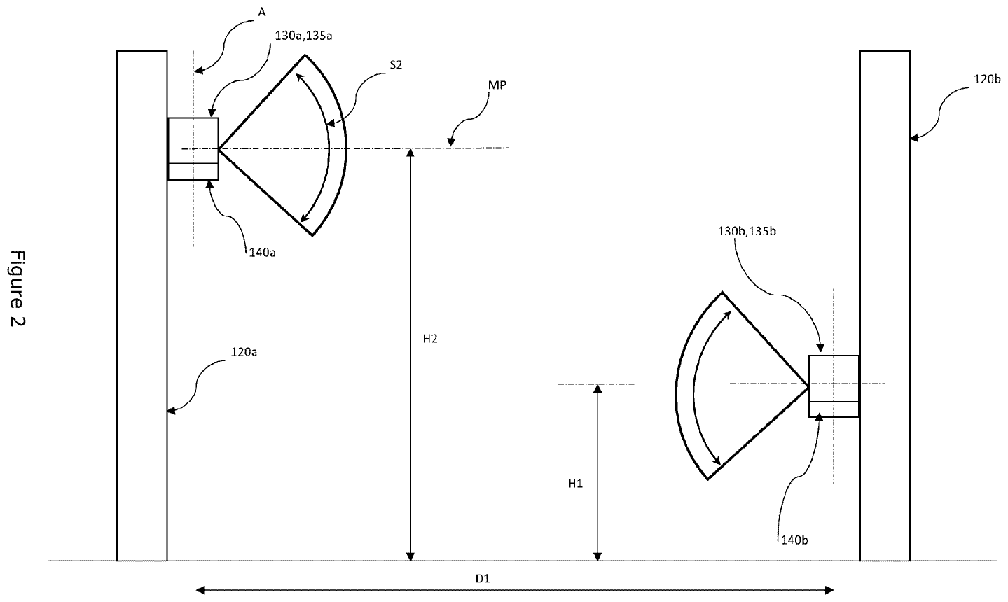

Referring additionally to FIG. 2, the first and second measuring columns 120a and 120b of the first to fourth measuring columns 120a to 120d are shown in more detail.

Each of the first to fourth measuring columns 120a to 120d comprises a respective lidar emitter 130a, 130b and a respective lidar receiver 135a, 135b (those for the third and fourth columns are not shown). Thus, each respective lidar emitter and receiver forms a lidar pair and can be contained in a single lidar module.

Each of the first to fourth measuring columns 120a to 120d also comprises a respective servo motor 140a, 140b coupled to the respective lidar emitter 130a to 130d and lidar receiver 135a to 135d of that measuring column.

The servo motor 140a, 140b, 140c, and 140d, coupled to the respective lidar emitter 130a to 130d and lidar receiver 135a to 135d of that measuring column, may be positioned at the top of the measuring column, or may be positioned at a height H from the bottom of the measuring column. In the illustrated embodiment, diagonally opposite servo motors 140b and 140d are mounted at a relatively low height H1 of 2 m and the other two diagonally opposite servo motors 140a and 140c are mounted at a relatively high height H2 of 7.5 m. However, in other embodiments the servo motors 140a to 140d can all be mounted at the same height H, such as at the base, middle, or top of the measuring columns.

The vertical rotation axis A of each servo motor 140a to 140d is positioned to be a first distance D1 from the vertical rotation axis of an adjacent servo motor 140a to 140d located in a first direction, and a second distance D2 from the vertical rotation axis of another adjacent servo motor 140a to 140d located in a second direction, where the first direction D1 and the second direction D2 are orthogonal to each other.

In some embodiments, the first distance D1 may be between 21 m and 23 m, and the second distance D2 may be between 10 m and 12 m. In some embodiments, the first distance D1 and the second distance D2 may both fall within the range 21 m to 23 m, and/or the first D1 and second D2 distance may be the same and in other embodiments the distance D1 and D2 may have any value suitable for the operating range of the lidar units. The first distance D1 and the second distance D2 may be accurately known from measurements taken during calibration of the measuring station 100.

Each servo motor 140a to 140d is configured to rotate the corresponding lidar emitter 130a to 130d and lidar receiver 135a to 135d about the vertical rotation axis A such that the lidar emitter 130a to 130d and lidar receiver 135a to 135d sweeps in a horizontal scanning motion across a measurement space MS within the area 110. The servo motors 140a to 140d rotate the corresponding lidar emitter 130a to 130d and lidar receiver 135a to 135d at a servo rotation rate R. The servo rotation rate R may for example be between 3 and 18 degrees per second and may be preselected during calibration of the measuring station 100.

In the illustrated embodiment, the horizontal scanning angle S1 is 90 degrees, such that each servo motor 140a to 140d moves its respective lidar emitter 130a to 130d and lidar receiver 135a to 135d from an orientation pointing towards an adjacent measuring column to the other adjacent measuring column. This can enable the lidar emitters 130a to 130d and lidar receivers 135a to 135d to sweep across and cover the entire measurement space MS in an efficient manner. As shown in FIG. 2, the movement plane MP for each lidar unit is orthogonal to the rotational axis A of the servo motor. In other embodiments the horizontal scanning angle S1 can be between 60 and 180 degrees and in some embodiments between 90 and 150 degrees. This can ensure that each lidar emitter and lidar receiver can “see” the facing surfaces of the object as the servo motor completes a measurement sweep. Where the first scanning angle is greater than 90 degrees, it can start with the measurement plane being outside of the quadrilateral such that the servo motor sweeps the emitter/receiver into, through and out of the measurement space. The center of the first scanning angle can for example be centered at the middle of the measurement space.

As illustrated in FIG. 1, a data processor or controller C is communicatively coupled to the servo motors 140a to 140d and lidar receivers 135a to 135d to receive orientational position data from the servo motors 140a to 140d and lidar data from lidar receivers 135a to 135d. The controller C can for example be a distributed system, with one or more local data processors optionally in communication with one or more remote servers.

Embodiments can utilize any suitable servo motors which can be precisely driven and provide orientational position data; in one example, Robotis XW540-T140-R servo motors can be used. Likewise, embodiments can utilize any suitable lidar emitters and receivers for obtaining distance information that can be used to generate a three-dimensional model; in one example, Hesai XT32, 32 channel lidar emitters and receivers can be used.

As illustrated in FIG. 2, each lidar emitter 130a to 130d is configured to emit lidar signals in a pattern resembling a sector of a circle, the arc of the sector being orientated in the vertical plane denoted as the scanning plane SP in FIG. 1. The lidar arc or scanning angle S2 in the illustrated embodiment is 90 degrees but can for example be between 60 and 180 degrees, and in some embodiments can be between 90 and 150 degrees. While in the illustrated embodiment the emitters/receivers are orientated such that the second scanning angle is centered at 90 degrees to the rotational axis A, in other embodiments the center of the second scanning angle can be centered at the middle of the measurement space.

Each lidar receiver 135a to 135d is configured to receive reflected lidar signals.

As a result, each lidar emitter 130a to 130d and lidar receiver 135a to 135d is configured to be rotated by its corresponding servo motor 140a to 140d through the horizontal scanning angle while emitting and receiving lidar signals across the vertical scanning angle S1. This arrangement may enable the lidar emitters 130a to 130d and lidar receivers 135a to 135d to build up an accurate three-dimensional map M such a point cloud of an object in the measurement space MS in a fast and efficient manner with minimal infrastructure.

The measuring station 100 may therefore receive an object for measuring in the area 200, such that the object is located within the quadrilateral formed by the four measuring columns 120a to 120d.

The lidar emitters 130a to 130d and lidar receivers 135a to 135d may then scan the object as the servo motors 140a to 140d repeatedly rotate the lidar emitters 130a to 130d and lidar receivers 135a to 135d through the horizontal scanning angle at the servo rotation rate R, allowing for the 3D map M to be generated of the object.

The three-dimensional map M of the object may not be a complete map of the shape of the object. Nonetheless, the data from the three-dimensional map M allows for a precise measurement of the overall length L, width W and height H of the object to be determined, so that those precise measurements may be used when carrying out logistical planning for transporting the object (for example, for shipping by sea, air, or road). Moreover, use of a three-dimensional map M for measurement of the object enables the object to be measured while on a carriage (e.g. a boat on a trailer) and the object can be discerned from the carriage, enabling fast measurement of the object.

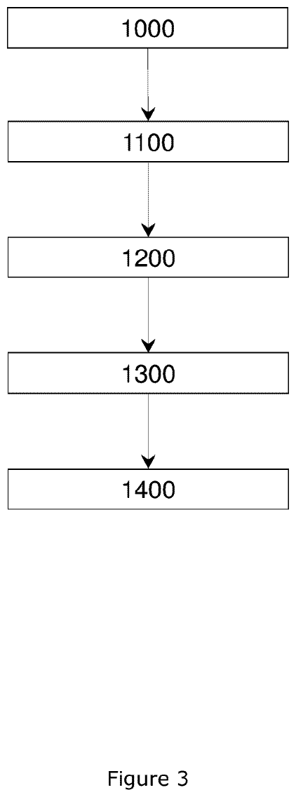

FIG. 3 shows a flowchart for measuring an object in the measuring station according to an embodiment.

At step 1000, the object is received into the measurement space MS of the measuring station 100, such that the object is fully enclosed in the quadrilateral formed by the measuring columns 120a to 120d.

At step 1100, the servo motors 140a to 140d begin to rotate the lidar emitters 130a to 130d and lidar receivers 135a to 135d on each of the measuring columns 120a to 120d. The rotation by the servo motors 140a to 140d is set to a chosen servo rotation rate R and sweeps the lidar emitters 130a to 130d and lidar receivers 135a to 135d through a horizontal scanning angle that includes the object. The servo motors 140a to 140d may sweep the lidar emitters 130a to 130d and lidar receivers 135a to 135d repeatedly through the horizontal scanning angle that includes the object. The lidar emitters 130a to 130d emit lidar signals throughout the rotation, and each of the lidar receivers 135a to 135d receive a reflected lidar signal, where the reflected lidar signal is a lidar signal that has been reflected from the surface of the object in the area 200.

At step 1200, each of the received reflected lidar signals are used in combination with each associated emitted lidar signal to calculate the travel time for the lidar signal from the lidar emitter to a point on the surface of the object and back to the lidar receiver. This then allows for the calculation of the distance from the vertical rotation axis of the associated servo motor 140a to 140d to a point on the surface of the object. The servo motor rotation rate R is then used to calculate the direction from the vertical rotation axis of the servo motor 140a to 140d in question to the point on the surface of the object. As such, for each received reflected lidar signal, a vector can be calculated from the vertical rotation axis of the servo motor 140a to 140d at the point of lidar signal emission to the detected point on the surface of the object.

At step 1300, each vector corresponding to each received reflected lidar signal is used to generate a three-dimensional map M of the object, the three-dimensional map M showing the shape of the parts of the object falling within the horizontal scanning angle of each measuring column 120a to 120d.

At step 1400, the three-dimensional map M is used, along with the known first distance D1 and the known second distance D2 separating the vertical rotation axis of each servo motor 140a to 140d from the vertical rotation axis of the neighbouring servo motor 140a to 140d, to determine a precise measurement of the overall length L, width W and height H of the object. The system can for example perform a pre-measurement scan of an empty measurement space to identify voxels which correspond to the ground so that the ground can later be distinguished from voxels which represent an object to be measured. A more detailed example of this is set out below.

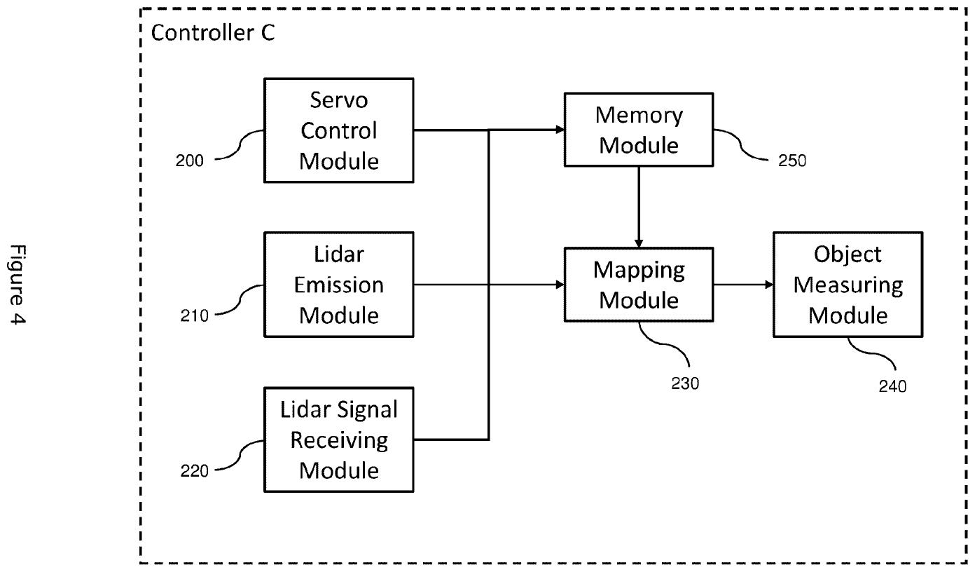

FIG. 4 shows the modules for controlling the measuring station 100, including the control of the servo motor, lidar emitter, and lidar receiver of each measuring column according to some embodiments. FIG. 4 also shows the modules used for calculating the precise measurements of the object in the measuring station 100. Each of the modules may form part of the controller C (as shown in FIG. 4), or may be implemented separately to the controller C.

A servo control module 200 is configured to control the movement of each servo motor 140a to 140d. Here, the servo control module 200 may select a servo rotation rate R, such that each servo motor 140a to 140d rotates its corresponding lidar emitter 130a to 130d and lidar receiver 135a to 135d through the horizontal scanning angle at the selected servo rotation rate R. The servo rotation rate R selected by the servo control module 200 may be stored in a memory module 250.

The memory module 250 may additionally store the first distance D1 and the second distance D2. The first D1 and second D2 distances may be set or otherwise known from the calibration of the measuring station 100.

A lidar emission module 210 is configured to control the emission of lidar signals from the lidar emitter 130a to 130d of each measuring column 120a to 120d, such that lidar signals are continuously emitted from each lidar emitter 130a to 130d across the vertical scanning angle.

A lidar signal receiving module 220 is configured to receive the reflected lidar signals received by each of the lidar receivers 135a to 135d for each of the measuring columns 120a to 120d.

A mapping module 230 is configured to receive, for each measuring column 120a to 120d, the servo rotation rate R from the servo control module 200, the lidar emission signals for each lidar emitter 130a to 130d from the lidar emission module 210, and the reflected lidar signals for each lidar receiver 135a to 135d from the lidar signal receiving module 220. The mapping module 230 may also be configured to receive the first distance D1 and the second distance D2 from the memory module 250. Then, for each reflected lidar signal received for each measuring column 120a to 120d, the mapping module 230 calculates the distance from the vertical rotation axis of that servo motor to the point on the surface of the object detected by that reflected lidar signal.

The mapping module 230 is then configured to generate a three-dimensional map M based on the servo rotation rate R and the calculated distances to the detected points on the surface of the object. The three-dimensional map M shows the parts of the object falling within the horizontal scanning angles of each of the measuring columns 120a to 120d.

An object measuring module 240 is configured to receive the three-dimensional map M, and calculate the overall length L, width W and/or height H of the object. The dimension data can be displayed on a display screen, stored locally and/or transmitted to a remote device for storage.

In one example, in order to extract the dimensions of a scanned object the following steps are performed. Initially, a scan of the measurement space is performed when free of any objects or obstacles. A three-dimensional map is then created that contains the empty measurement space. Based on the extent of the scanning area, the limits of the three-dimensional map can be cropped to result in a full scan of the ground of the measurement space without anything on top of it. This can be done only once during the installation of the system in order to get the reference ground of the measurement space, or when a recalibration of the system is desired due to a change in the ground within the measurement space.

With the three-dimensional map of the empty ground loaded, the algorithm can proceed to scan the object and create another three-dimensional map that contains the ground that the object is on and the object itself. In order to properly measure the dimensions of the object, the ground can be removed from the map since an irregular ground can affect the accuracy of the measurements. To accurately remove the ground from a three-dimensional map, voxels in the three-dimensional map can be compared to corresponding voxels in the ground-only map. Any points that are at or below the voxels of the ground-only map can be removed and thus the ground is removed from the three-dimensional map of the object.

A next step can be to remove unwanted voxels from the map that are erroneous or that belong to other elements of the scan such as rain and other particles that were included in the map. At the same time, voxels in the map can be smoothed by applying a statistical outlier removal algorithm based on the Euclidean distance of the points in the map. The same filtering can also be used before the removal of the ground to eliminate and smooth any points that are erroneous and are very close to the ground.

After obtaining a smooth and filtered map of the object without the ground, the algorithm can detect how the object is oriented inside the measurement space along the three axes of rotation around the center of the object. A few key metrics of the object are measured that include the moment of inertia of the object, the eccentricity, the center of mass and the Eigenvalues and vectors of the principal axes. With this information, the Oriented Bounding Box of the object can be computed and transformed in three-dimensional space to orient it straight in the measurement space without any other rotations along the other axes.

Finally, the dimensions of the object can be determined. Since the object is properly oriented in space, the extents of the outermost points of the object can be measured. The extents can then be filtered by a median of the points in order to exclude any erroneous points that were not previously removed and can affect the dimensions of the scanned object.

The object measuring module 240, or another local or remote module, can optionally determine an optimal configuration to fit objects into a transportation space such as a cargo vessel. This can commonly be referred to as the “bin packing” problem. This is a Non-deterministic Polynomial-Time Complete problem, meaning that each solution can be verified quickly in polynomial time and a brute force search algorithm can find a solution by trying all possible solutions.

One example way of improving the brute force search algorithm is to apply heuristics and empirical results. One such heuristic is the “first fit decreasing” in which we first sort all objects in decreasing order of size in two dimensions so that the biggest object is first and the smallest last. We then create a binary tree with all the space available and insert as a root node the first object. The object then gets two child leaf nodes with the leftover empty space available along one dimension and the remaining empty space along the other dimension. We keep inserting the objects at the first available leaf that the object can fit and we create more child leaf nodes of empty space for each of the inserted objects. The algorithm stops once all objects are placed or if there is no available space left.

While the optimal configuration description above focuses on how the problem can be solved in two-dimensional space, the skilled person will, with the benefit of the present disclosure, appreciate how to solve a more complex problem in three-dimensional space.

Whilst certain embodiments have been described, these embodiments have been presented by way of example only and are not intended to limit the scope of the application. Indeed, the novel devices, and methods described herein may be embodied in a variety of other forms; furthermore, various omissions, substitutions, and changes in the form of the devices, methods and products described herein may be made without departing from the scope of the present application. For example, while the measuring station of the described embodiments is arranged with a vertical scanning plane SP and a horizontal movement plane MP, these can be reversed by rotating servo motors by over 45 degrees, such as 90 degrees, such that the servo motors sweep laterally scanning lidar units vertically through the measurements space; embodiments extend to various orientations of scanning plane SP and movement plane MP with non-parallel relationships. Moreover, the measurement station according to embodiments can have two or more measuring columns in any suitable form, defining a measurement space between them. Moreover, the controller can be arranged to transmit the range and servo motor orientation data to a remote server for generation of the 3D model and/or object dimension data and/or optimal configuration data, in which case the object dimension data and/or optimal configuration data and object ID can be transmitted back to the measuring station and/or a local server for display to a user. Moreover, while the above embodiments utilize lidar emitters and receivers, embodiments can use any suitable range finding sensors. In some embodiments, the object dimension data can be compared with alleged object dimension data supplied by an entity paying for the object to be transported and a price quoted to the entity for the transportation can be flagged or automatically adjusted based on any differences between object dimension data and the alleged object dimension data; this can be performed by a comparison algorithm running on the controller. The word “comprising” can mean “including” and therefore does not exclude the presence of elements or steps other than those listed in any claim or the specification. The mere fact that certain measures are recited in mutually different dependent claims does not indicate that a combination of these measures cannot be used to advantage. The accompanying claims and their equivalents are intended to cover such forms or modifications as would fall within the scope of the application.

What is claimed is:

1. A measuring station for measuring an object, the measuring station comprising:
a plurality of measuring columns positioned to define a measurement space between them,
wherein each measuring column comprises a range finding sensor and a servo motor coupled to the range finding sensor,
wherein each servo motor is configured to rotate a respective range finding sensor about a rotation axis of the servo motor, the range finding sensor being rotated across a first scanning angle directed into the measurement space in a movement plane,
wherein each range finding sensor is configured to transmit and receive range finding signals in a second scanning angle defining a scanning plane, the scanning plane being non-parallel with respect to the movement plane, and
wherein the measuring station further comprises or is in communication with a controller configured to:
receive range data from the range finding sensors and angle data from the servo motors describing the angle of the range finding sensors when obtaining the range data;
execute a model generation algorithm for generating a scale, three-dimensional map of the object;
execute an object measurement algorithm for obtaining measurement data comprising the length, width and/or height of the object from the three-dimensional map of the object; and
output the measurement data.

2. The measuring station according to claim 1, wherein the plurality of measuring columns comprises first to fourth measuring columns, each measuring column being positioned at a respective corner of a quadrilateral forming the measurement space.

3. The measuring station according to claim 2, wherein the rotation axis of each servo motor is positioned to be a first distance from the rotation axis of an adjacent servo motor located in a first direction, and a second distance from the rotation axis of another adjacent servo motor located in a second direction, and wherein the first direction and the second direction are orthogonal to each other.

4. The measuring station according to claim 3, wherein the first distance is at least 5 meters, and wherein the second distance is at least 5 meters.

5. The measuring station according to claim 2, wherein the first and third range finding sensors are non-adjacent and mounted at a respective first mounting heights which are the same or distinct from one another but each of which is greater than a second mounting height or heights at which the non-adjacent second and forth range finding sensors are mounted.

6. The measuring station according to claim 5, wherein first height is greater than 5 metres and the second height is less than five meters.

7. The measuring station according to claim 1, wherein the first scanning angle is between 60 and 180 degrees and wherein the first scanning angle is centered on the center of the measurement space.

8. The measuring station according to claim 1, wherein the second scanning angle is between 60 and 180 degrees and wherein the second scanning angle is centered on the center of the measurement space.

9. The measuring station according to claim 1, wherein the servo rotation rate of each servo motor is between 3 and 18 degrees per second.

10. The measuring station according to claim 1, wherein the movement plane is horizontal and the scanning plane is vertical with respect to a ground plane on which the measuring columns are mounted.

11. The measuring station according to claim 1, wherein each range finding sensor comprises a lidar emitter and a lidar receiver.

12. A method of measuring an object, the method comprising:
identifying an object to obtain identification data;
while the object is located within a measurement space defined between a plurality of measuring columns, each measuring column comprising a range finding sensor and a servo motor coupled to the range finding sensor, rotating the range finding sensors through a first scanning angle while emitting and receiving range finding signals in a second scanning angle that is non-parallel with respect to the first scanning angle; and
at a controller:
receiving range data from the range finding sensors and angle data from the servo motors describing the angle of the range finding sensors when obtaining the range data;
executing a model generation algorithm for generating a scale, three-dimensional map of the object;
executing an object measurement algorithm for obtaining measurement data comprising the length, width and/or height of the object from the three-dimensional map of the object; and
and outputting the measurement data with the identification data for transmission to a user.

13. A computer implemented method of measuring an object, the method comprising, at a controller:
receiving identification data identifying an object;
receiving range data from a plurality of range finding sensors and angle data from a plurality of servo motors describing the angle of the range finding sensors when obtaining the range data and executing a model generation algorithm for generating a scale, three-dimensional map of the object;
executing an object measurement algorithm for obtaining measurement data comprising the length, width and/or height of the object from the three-dimensional map of the object; and
outputting the measurement data with the identification data for transmission to a user.

14. (canceled)

15. (canceled)
